(19) United States
(12) Patent Application Publication
(10) Pub. No.: US 2012/0246137 A1
(43) Pub. Date: Sep. 27, 2012

(54) VISUAL PROFILES

(76) Inventors: Satish Sallakonda, Dublin, CA (US); Anton Murauyou, Minsk (BY)

(21) Appl. No.: 13/425,310

(22) Filed: Mar. 20, 2012

Related U.S. Application Data
(60) Provisional application No. 61/466,393, filed on Mar. 22, 2011.

(51) Int. Cl. G06F 17/30

(52) U.S. Cl. 707/709; 707/770; 707/E17.108

(57) ABSTRACT

A method for generating a visual profile is provided. User-specific data is extracted from various data repositories. The data is presented to the user for selection for inclusion in a visual profile. A visual profile is generated using the data selected by the user by manipulating the data in a visual manner and/or generating visual depictions of the data using a database of multimedia content items. Visual profiles may be displayed and/or searched.

### CLAIM OF PRIORITY

The present application claims benefit of priority under 35 U.S.C. §119 to U.S. Provisional Patent Application Ser. No. 61/466,393, titled “VISUAL PROFILES,” and filed Mar. 22, 2011, the entire contents of which are incorporated by reference herein.

### FIELD OF THE INVENTION

The present invention generally relates to visual profiles. More specifically, the present invention relates to generating and viewing visual profiles.

### BACKGROUND

Resumes are used by those seeking employment (job-seekers) to describe an individual's work experience, education, skills, achievements, and provide an overall summary of the individual's career. Resumes are typically comprised of text that includes the names of the places the job-seeker has worked, titles held by the job-seeker, dates of employment, and specific tasks performed at each place of employment. This text is often stored in a digital document, such as a searchable PDF or Microsoft Word document. A job-seeker applies for a job by submitting his resume to a recruiter, hiring manager, or other decision-maker at the potential place of employment.

Job portals and websites such as Monster, Hot Jobs, and Dice provide resume import tools that automatically create a text-based job-seeker profile. Users may also enter data manually. This data is categorized so that recruiters can easily search for candidates with specific qualities by keyword.

Social recruitment platforms such as LinkedIn and Xing are also used by recruiters to search for professionals to fill positions. These platforms allow users to create a resume-like online identity and publish it for others to view their profile and reach out to them for potential job opportunities.

Job-seekers continue to seek new ways to differentiate themselves from other job-seekers. Countless books have been written, describing ways to get more attention from the decision maker and/or “tweak” resumes in order to trick automated resume readers that search for keywords. Job-seekers have even made compact discs that include writing samples, videos and PowerPoint presentations, and have provided these discs to potential employers as digital resumes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that represents a network architecture and delivery system on which an embodiment may be implemented.

FIG. 2 is a block diagram that represents a computing system on which an embodiment may be implemented.

FIG. 3 is a flow diagram representing a potential user experience flow in an embodiment.

FIG. 4A represents an example user interface featuring an “introduction” slide in an embodiment.

FIG. 4B represents an example user interface featuring a “background” slide in an embodiment.

FIG. 4C represents an example user interface featuring an “experience” slide in an embodiment.

FIG. 4D represents an example user interface featuring a “focused experience” slide in an embodiment.

FIG. 4E represents an example user interface featuring a “expertise” slide in an embodiment.

FIG. 4F represents an example user interface illustrating multiple editing features in an embodiment.

FIG. 5A1 represents an example user interface featuring visual profile player embedded in an embodiment (a webpage).

FIG. 5A2 represents an example user interface for a visual profile player played inline in an embodiment (a webpage).

FIG. 5B represents an example user interface for a full-screen visual profile player in an embodiment.

FIG. 5C represents an example visual profile slide in an embodiment.

FIG. 6 is a block diagram that represents a computing system on which an embodiment may be implemented.

FIGS. 7A-C represent an example webpage that is generated with visual elements in an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Job seekers are looking for ways to better present themselves to potential employers, and employers are looking for ways to find out what they want to know about candidates without reading through a traditional, boring resume. In an embodiment, job seekers can create a visual profile that is more appealing, and that creates a more useful and interesting view of a job seeker's abilities, qualifications, and accomplishments. Thus, a visual profile may be used as a visual resume. A visual profile is a slide show, video presentation, or other multimedia experience that conveys a job seeker's talents in a visually stimulating manner. A visual profile may be created automatically by gathering data about the job seeker from multiple data sources such as existing resume data and profile information from job portals and social networking sites (including professional networking sites). Job seekers can then edit, publish, export (to different formats), print, email, download, or otherwise direct others to their visual profile. In addition, job seekers may embed their visual profile into web pages. Visual profiles may also be used for purposes other than gaining employment. For example, a user of visual profiles may embed a visual profile in a blog to lend credibility to the publication. Organizations can find internal talent by searching against the aggregated data sources and looking at visual profiles in a holistic view. Links to a visual profile may be provided in email signatures to foster client development activities. People may even post visual profiles to social networking sites.

### Functional Overview

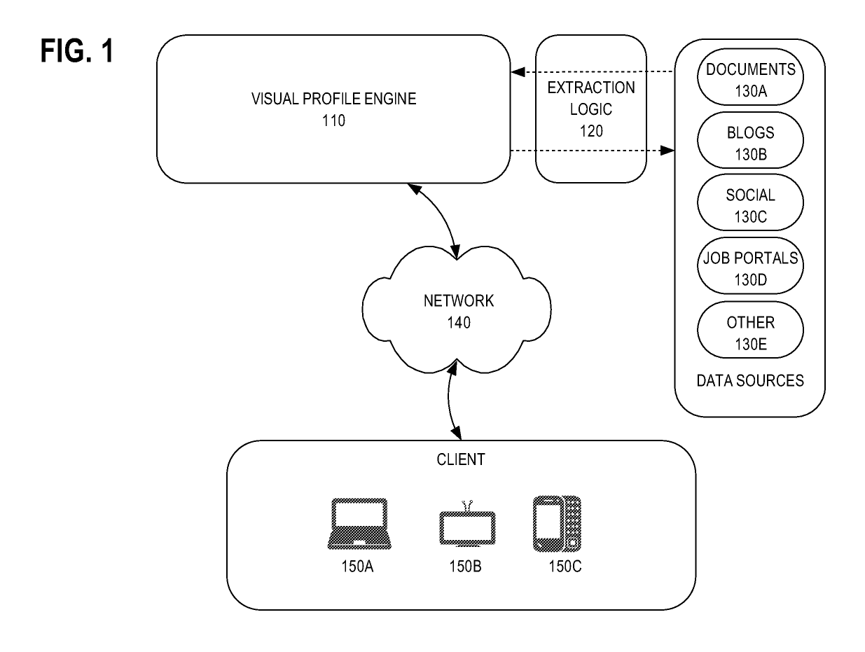

FIG. 1 is a block diagram that represents network architecture and delivery system on which an embodiment may be implemented. A visual profile engine 110 is accessible by client computing devices 150A-150C via network 140. Client computing devices 150A-150C may be personal computers, laptops, smartphones, internet-enabled television devices or components, or any other client-facing network-enabled device. Network 140 may represent multiple networks such as the internet or one or more intranet networks.

An extraction logic 120, which is coupled to visual profile engine 110, is configured to extract user-specific data from external data sources, such as documents 130A, blogs 130B, social and professional networking sites 130C, job portals and websites 130D, and other data sources 130E, which may include profile information stored on smartphones or in other databases or data files. In an embodiment, extraction logic is integrated into visual profile engine 110. Visual profile engine uses the data extracted from these data sources to generate a visual profile, which may be displayed to any one of client devices 150A-150C.

### Visual Profile Engine

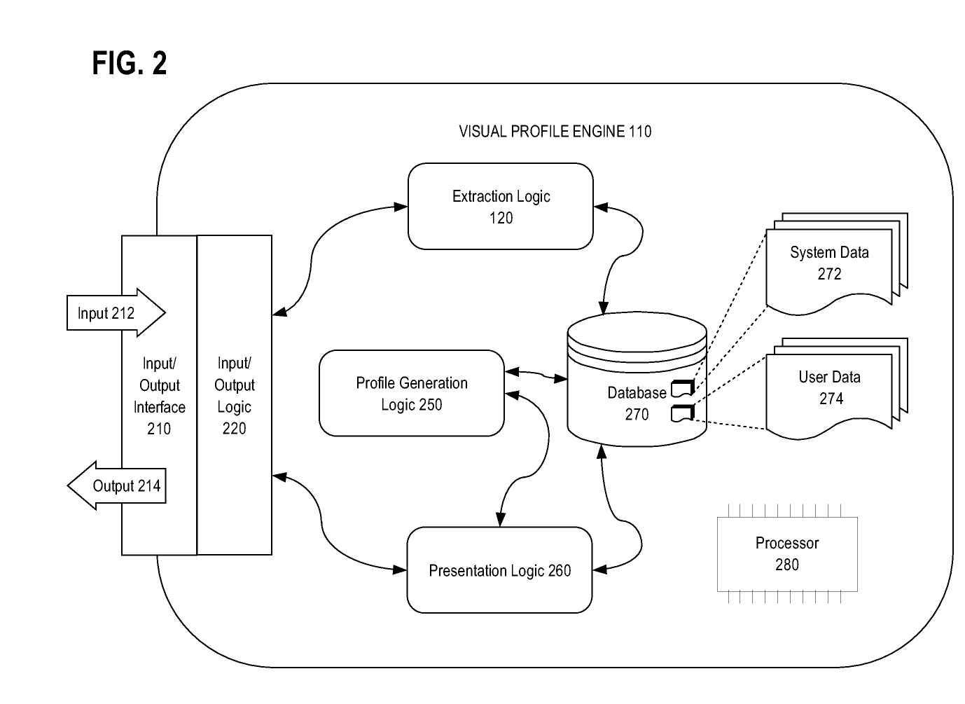

FIG. 2 is a block diagram that represents a computing system on which an embodiment may be implemented. Referring to FIG. 2, an input 212 is received by visual profile engine 110 at an input/output (IO) interface 210. IO interface 210 may be a network interface such as a Bluetooth or Ethernet-based interface. Input 212 may include data received from a job portal, such as job portal 130D.

An IO logic 220 is coupled to IO interface 210. IO logic is configured to parse and distribute incoming data and prepare output 214 for sending via 10 interface 210, according to an embodiment. IO logic 220 may implement one or more communications protocols. IO logic 220 is coupled to extraction logic 120 and presentation logic 260, in an embodiment. IO logic 220 is also coupled to a database 270, in an embodiment. Presentation logic 260 and profile generation logic 250 are also coupled to database 270 in an embodiment.

Database 270 may include system data such as system data 272 and user data such as user data 274 in an embodiment. IO logic 220, extraction logic 120, profile generation logic 250, presentation logic 260, and database 270 are all coupled to a processor 280, which executes instructions provided by these elements of visual profile engine 110.

### Data Sources

Data about users is available from many data sources. Most users have their work experience, education, summary, skills, and expertise data documented in a resume. This is a direct data source. Other direct data sources may include any other information that a user may provide.

The resume information, including additional information such as recommendations, patents, languages and other important data is often stored on social websites such as LinkedIn. Some users author blog posts or comment on blog posts of others. These authored blog posts may even be referenced or talked about in other news articles. Patent information is publicly available via search engines. Users often microblog on various platforms such as Twitter. Users even mention each other on social websites. If the user is author of a book, the book and author reviews are available on sites like Amazon. External data sources may include any system where user's information is stored and available.

Talent profile information like competencies, resume, performance ratings, are often stored in internal Human Resource, Recruiting and Talent Management systems. In addition, Companies have internal wiki's, blogs, and document management systems to enable collaboration among internal employees.

### Data Extraction

Extraction logic 120 is configured to extract data from various sources, according to API's, crawling techniques, and other data source-specific instructions stored in system data 272 in an embodiment. For example, certain data sources, such as blogs, may provide data via RSS or Atom feeds. If extraction logic 120 receives instructions from a user to gather information about that user from the user's blog, extraction logic determines whether that blog supports RSS or Atom feeds based on information stored in system data 272 about that blog type or blog provider. If so, then extraction logic gathers data from the blog, and stores the data in the user data table 274 in database 270.

If instructions exist for gathering data from a particular data source or a particular type of data source, then that data may be extracted by extraction logic 120. Some data sources may require that requests for data conform to an Application Programming Interface (API). In such cases, instructions for interfacing with these data sources will be stored in system data table 272 and executed by extraction logic 120.

Extraction logic includes analysis and data parsing logic (not shown separately) for parsing and analyzing data extracted from various data sources. Blog data may be analyzed to determine which portions of the blog data are more important for the purposes of creating a visual profile. For example, the titles of blog postings may be analyzed to determine common themes, such as technology, law, or other topics. The titles may carry more weight than the other text gathered from blogs. Resume documents may be analyzed to determine job titles, dates, and key accomplishments based on document formatting code. Social websites and other data sources may be analyzed according to known HTML tags and other data markers known to provide meaning in the context of those particular data sources.

New data sources may be found using crawling techniques. For example, a web crawler may search for basic information about users for which it already has data. If the crawler finds a new data source, the new data source may be compared to data stored in database 270 to determine if the new data source has data that augments the data in database 270. If a new data source is found, users may be presented with the option of including data from the new data source in their visual profiles.

Data that is extracted, analyzed, and parsed from data sources may be stored in user data table 274 in an embodiment. Data items are associated with individual users of the system for use in the generation of visual profiles for that individual. Data items that are collected from data sources may include text, pictures, documents, video content, and other data such as multimedia presentations using flash or Silverlight technology.

### Visual Profile Generation and Presentation

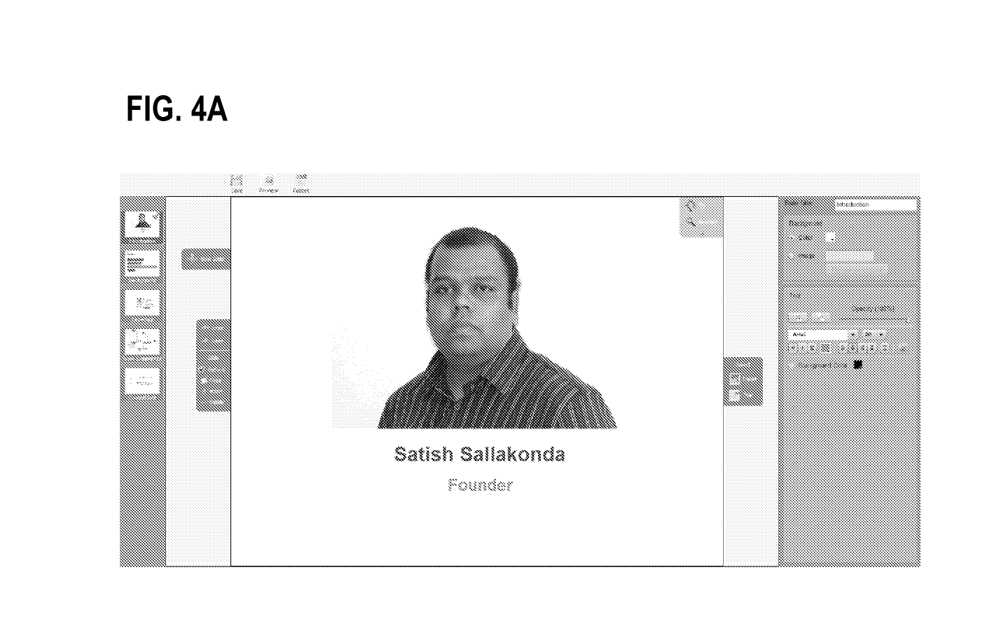

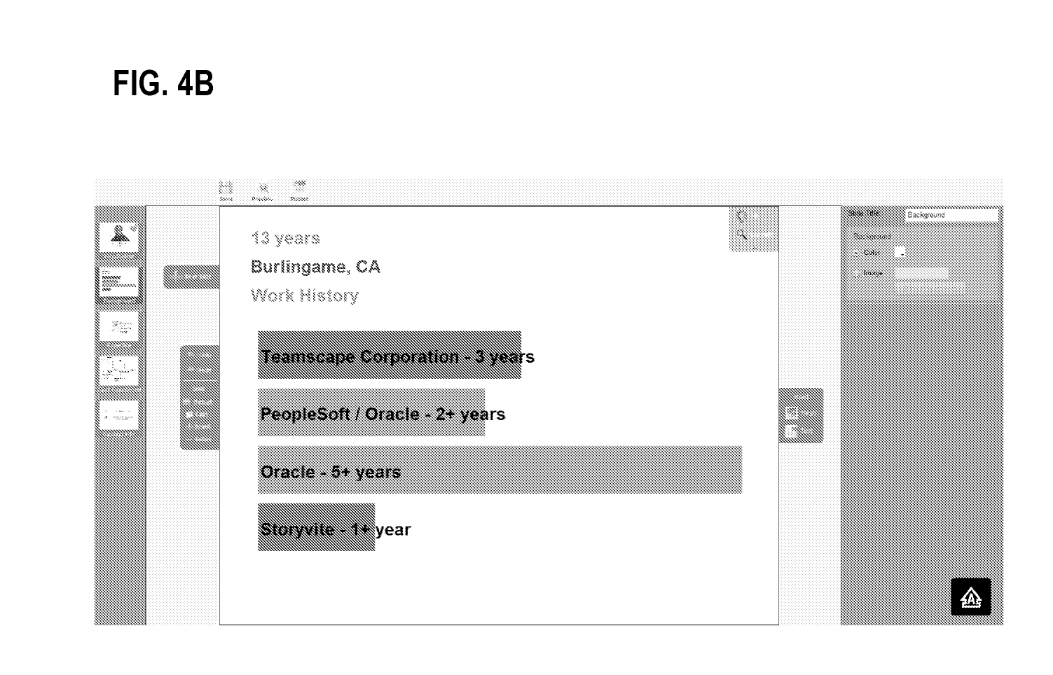

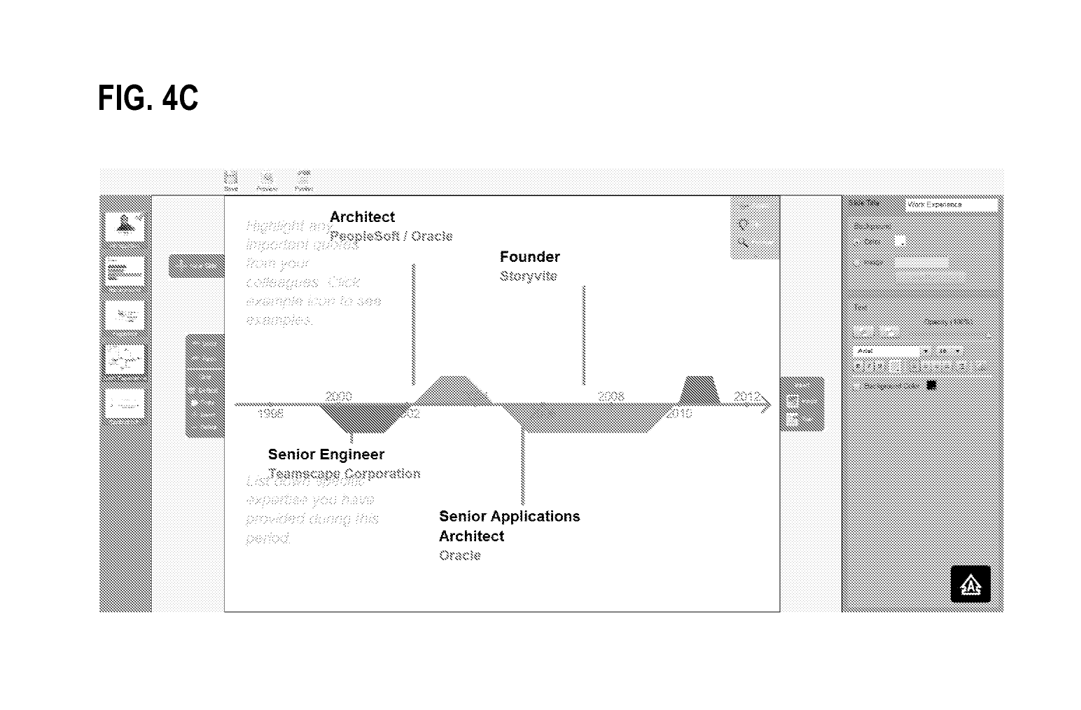

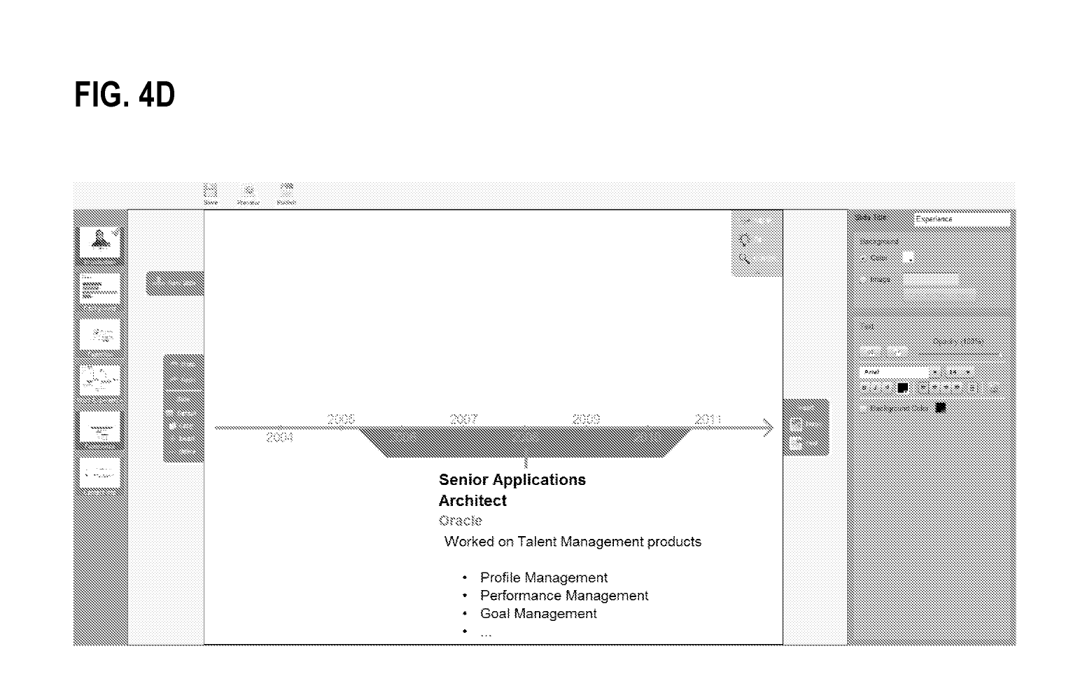

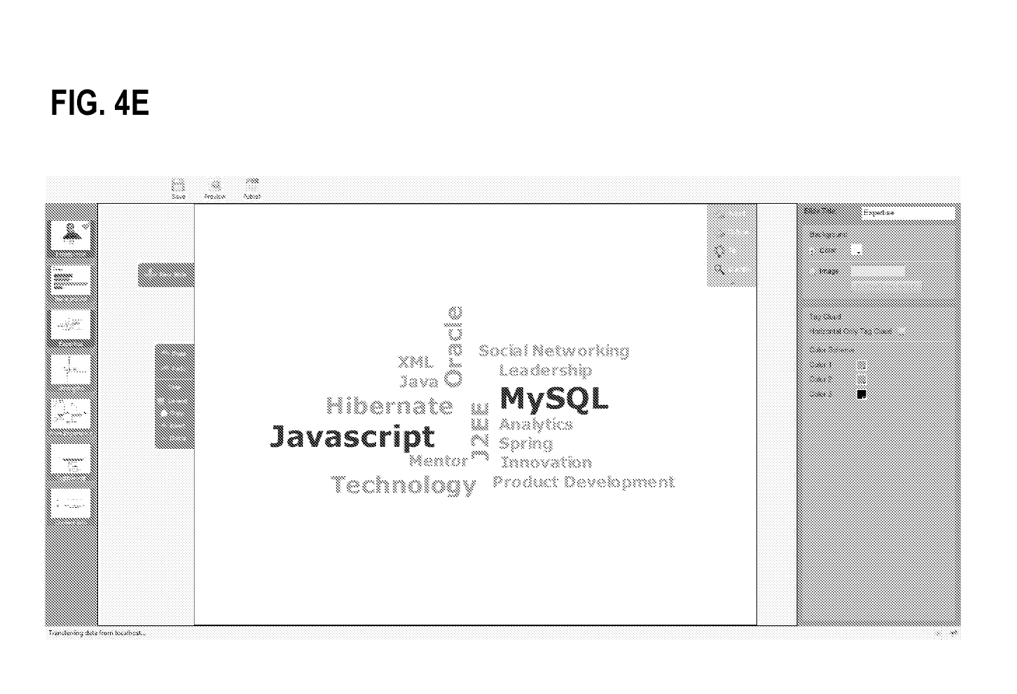

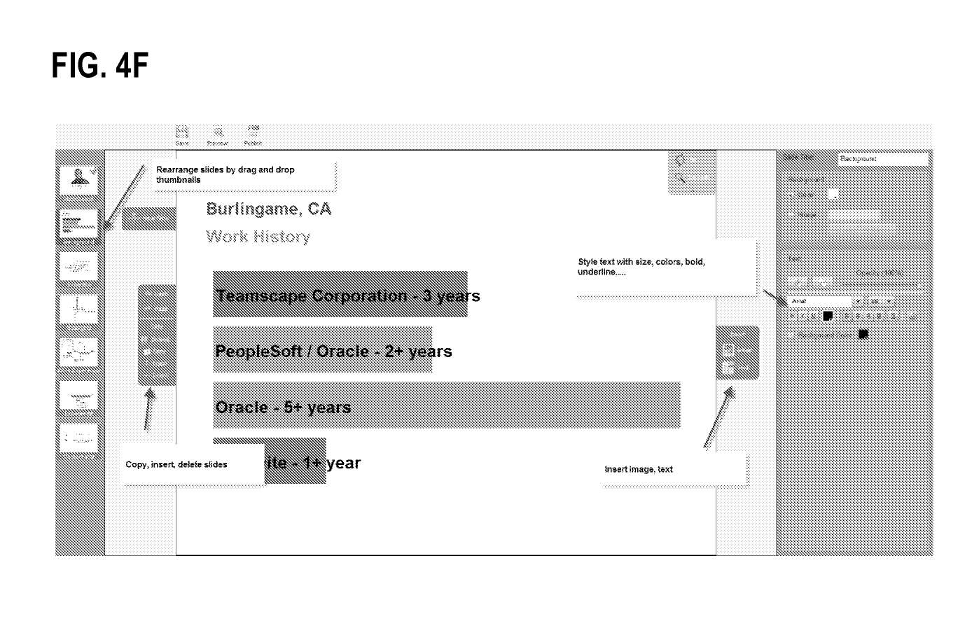

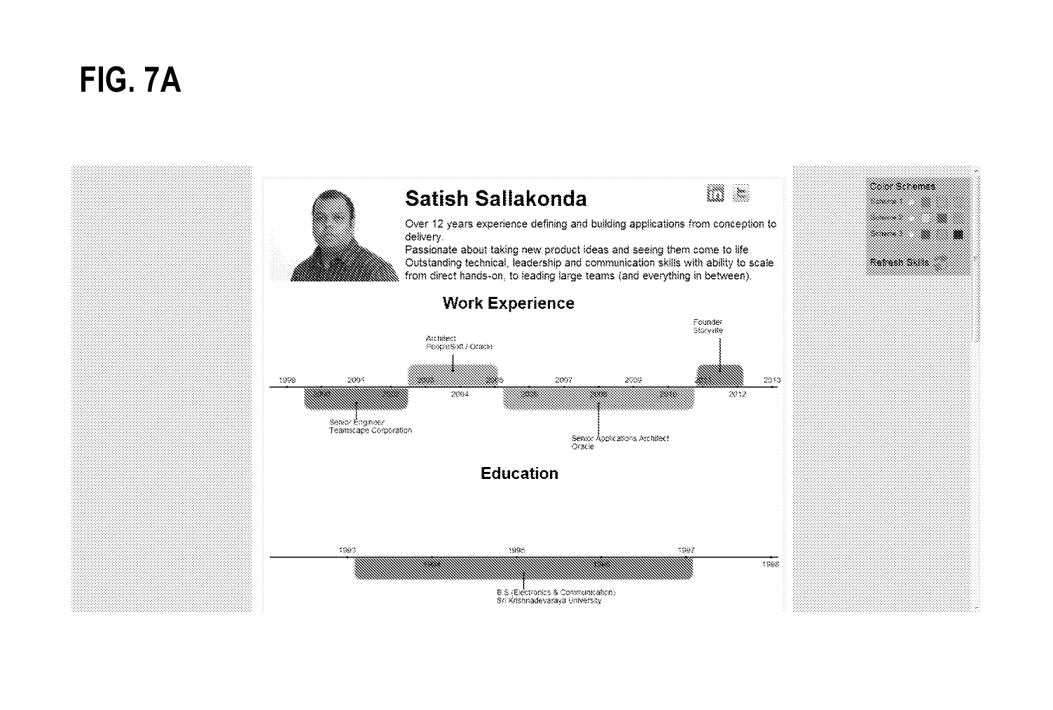

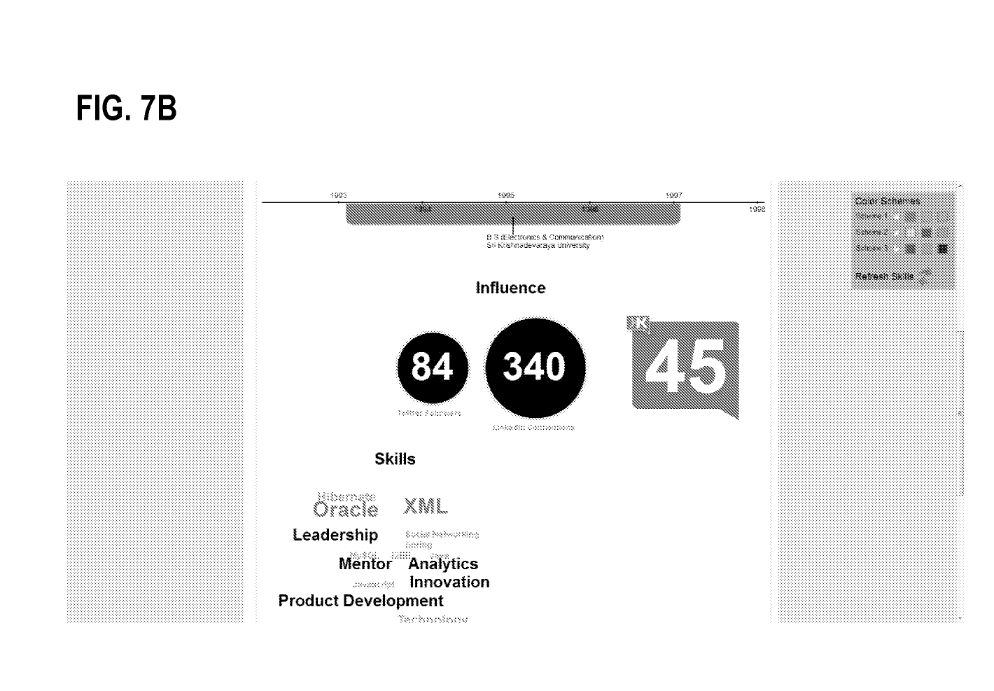

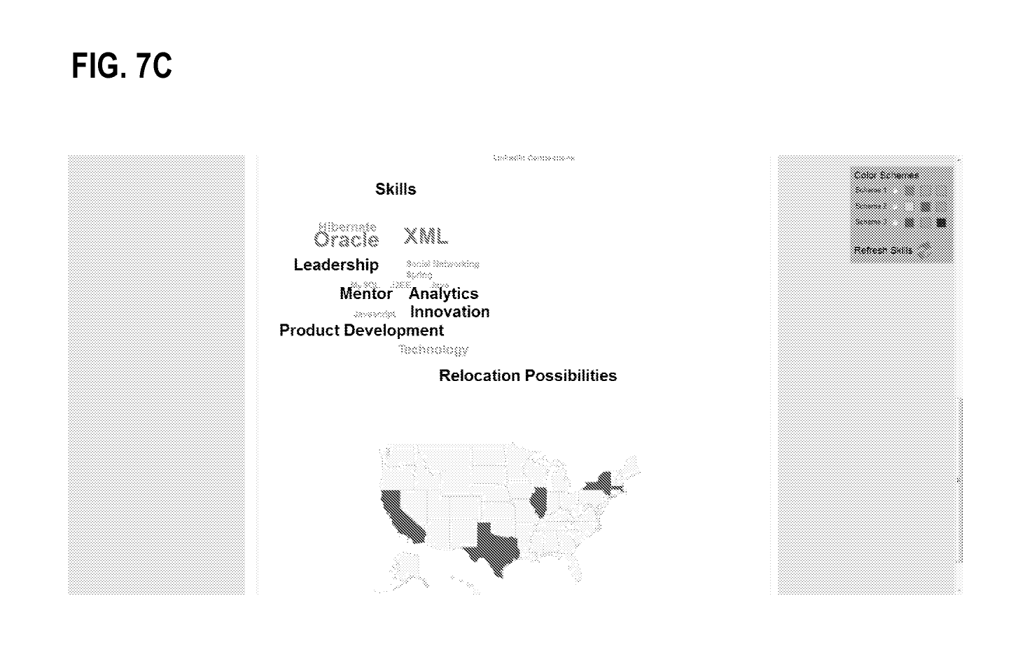

A visual profile allows a user to tell a professional story that describes that user's career, accomplishments, and areas of expertise. A visual profile may be shared online in blogs, websites, and email and may be integrated easily into any recruitment system and potentially any system that would like to embrace visual profiles. In an embodiment, an online (web-based) editor, desktop client software, and mobile platform to create, edit, manage, and view visual profiles is provided. FIG. 4A represents an example user interface featuring an “introduction” slide of such software in an embodiment. Although embodiments depicted herein refer to slides, other embodiments are not limited to the use of slides in visual profiles. For example, a complete web page may be generated using the methods described in FIG. 7A-C. In addition, other multimedia presentations, such as video files and Flash movies that do not require the use of slides, may be generated using techniques described herein.

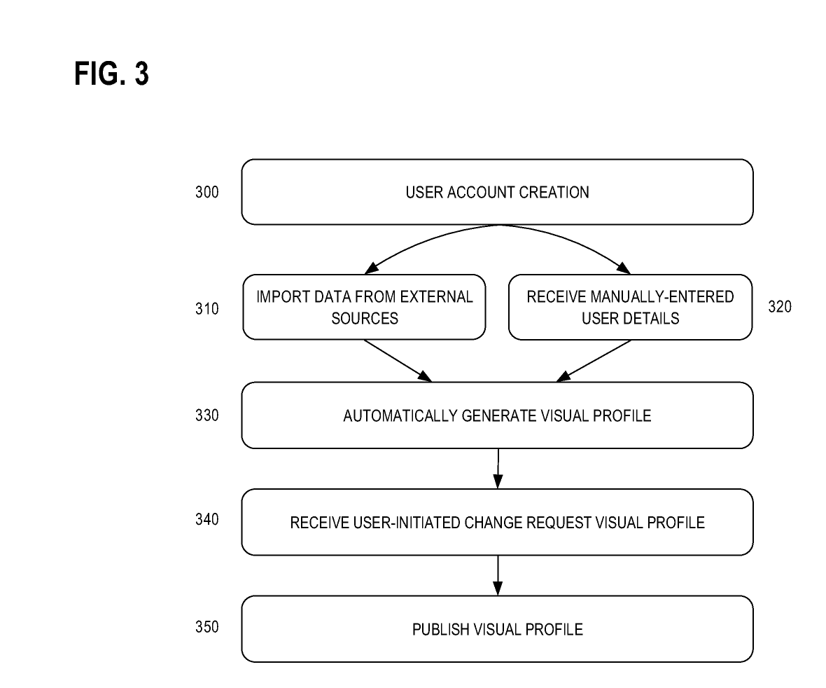

FIG. 3 is a flow diagram representing a potential user experience flow in an embodiment. At step 300, the user creates an account. At step 310, data is imported from external sources. At step 320, manually entered user details are received. At step 330, a visual profile is automatically generated. At step 340, the user initiates a request to change the visual profile. At step 350, the visual profile is published.

In an embodiment, data is extracted from various data sources, such as resumes, human resources, talent systems, social websites, blogs, wiki articles, microblog sites, and other documents and external sources. This data is extracted using extraction logic 120 as described above. Once the data is extracted, the data is analyzed to identify information like expertise, areas of interest, work experience, education, organization and institutions affiliated with, recommendations, constructive data (e.g. if someone said anything positive about the user), blog posts that are authored by the user and/or popular and so on.

Once the information is analyzed, the data is presented to the user to choose which pieces of this information will go into building the visual profile. Once the user has chosen the relevant pieces the Visual Profile is automatically built. For example, a list of keywords may be extracted from several of these data sources. This list may include keywords determined to be important based on location, surrounding tags, frequency, or other weighting mechanisms. An example list may include only nouns, or may be filtered by using a database of keywords deemed important for resume or profile purposes. The user may determine that one or more of the keywords do not apply, and remove it from consideration. The user may also add keywords or change the weight associated with a keyword.

Other extracted information presented to the user may include dates, company names, and titles of places of employment. The user may edit these items, add items not appearing in the list, or remove items altogether. The user may also associate items with one another. For example, a user may associate keywords and dates with a particular place of employment.

Keywords may be compared to a database of content. Content may include video content, images, and other types of visual media. Although this document focuses on the generation of visual profiles, audio content and other sensory-based content may also be included. The content may be stored in system data table 272 in database 270. Each content item may be associated with one or more keywords, places of employment, dates, or otherwise associated with the types of data extracted from data sources. There may also be many content items associated with the same keyword or other extraction data.

A slide or other multimedia data container such as a frame in a video or flash movie may be created using a content item that matches a keyword gathered from data sources associated with the user. For example, a picture of a coffee mug with the word “JAVA” on the side may be displayed on a slide if the user's profile has a strong affinity for the Java programming language. Other words, such as “innovation” or “leadership” may be associated with interesting depictions of those words that provide extra emphasis in the context of visual profiles. Users may also associate their own content with certain keywords. For example, a user may upload an audio file of a classical music piece to associate with that user's MFA degree. This music may automatically play when the education portion of the profile is being viewed.

Other visual depictions may be generated based on the information gathered from data sources. For example, a graph may be generated to graphically depict the amount of time the user has spent at his prior places of employment. Such a slide is shown in the “background” slide shown in FIG. 4B. This information is generated by profile generation logic 250 using graphing techniques applied to the dates gathered from data sources associated with the user.

FIG. 4C shows an example timeline that may be generated using these dates. Although both of these slides use date information, the information is presented differently, and one view may be more favorable than the other for a particular user. In addition, users may choose which data to provide with the timeline. For example, FIG. 4C shows that the user spent a comparatively significant amount of time as a “Senior Applications Architect”—an impressive title. The timeline of FIG. 4C draws special attention to this title in a way that a traditional profile or resume does not. For additional emphasis on this title, FIG. 4D shows a “focused” view of a particular job.

Another way to present keywords gathered from or derived from data about a user that is gathered from data sources is to generate and display a tag cloud of text. An example of a tag cloud is shown in FIG. 4E. Tag clouds display keywords in a visually appealing way. They may show each word in a particular font, size color, and/or orientation that is determined based on the weight, importance, or other attributes of that keyword.

Other information may be added to the visual profile. For example, charts, introductory text, and audio-visual information may be added. In addition, recommendations gathered from social networking sites may be captured and displayed on slides. In an embodiment, users may choose which recommendations are displayed.

FIG. 4F represents an example user interface illustrating multiple editing features in an embodiment. This interface features a drag-and-drop feature that allows users to change the order in which slides are presented. Additional slides or other multimedia content may be inserted. Background images or multimedia content may be used to make slides more appealing, and traditional text and web-editing tools are also available in an embodiment. In addition, visual profiles may be exported to different file formats, including PowerPoint presentations, Flash movies, Silverlight movies, interactive web pages or slide shows featuring JavaScript or other technologies, AVI movies and other video files, or any other visual format.

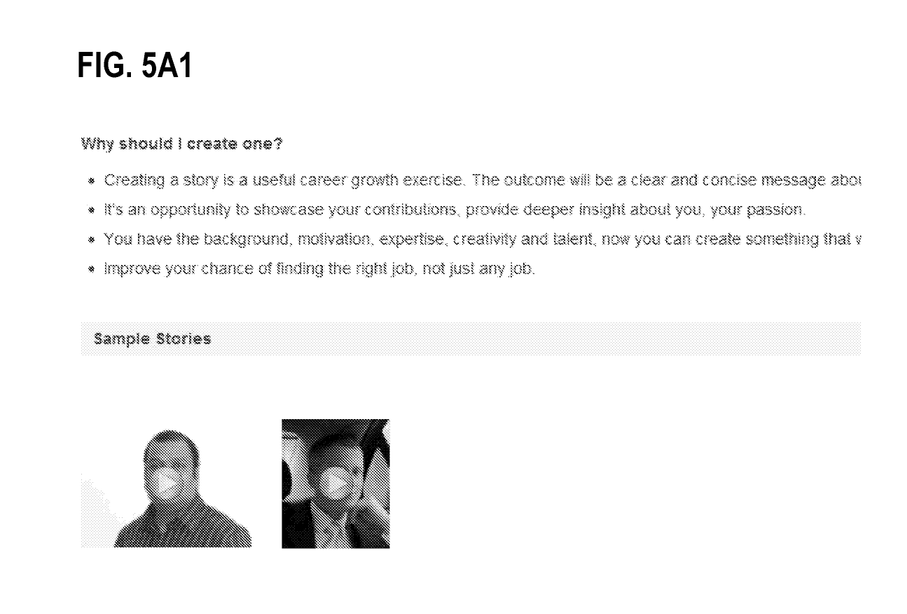

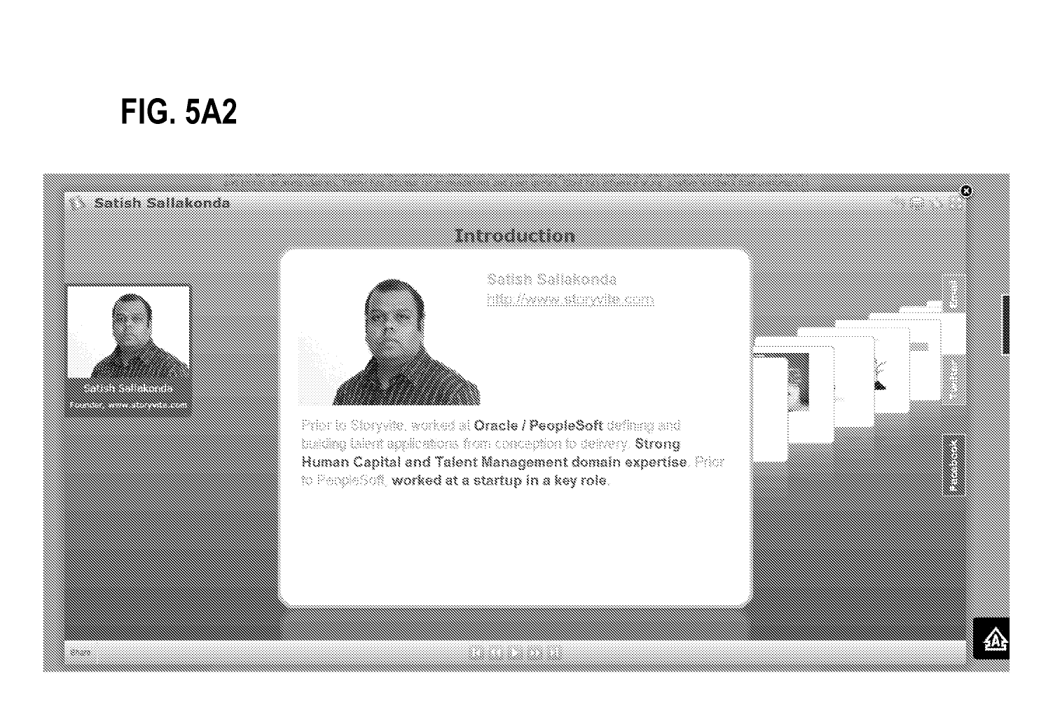

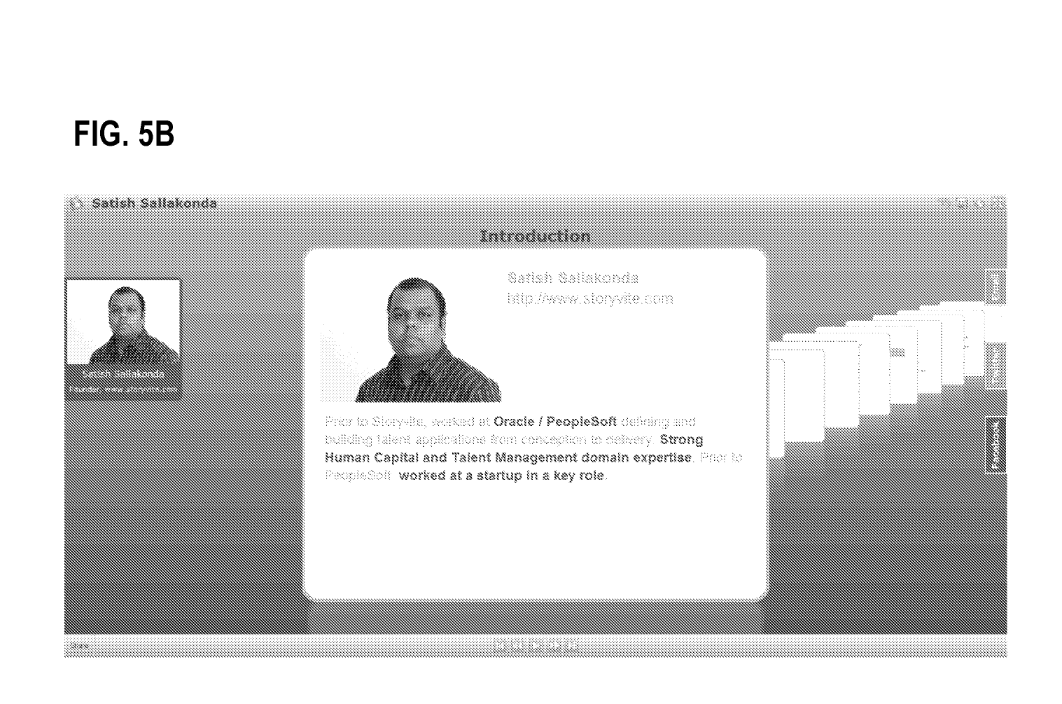

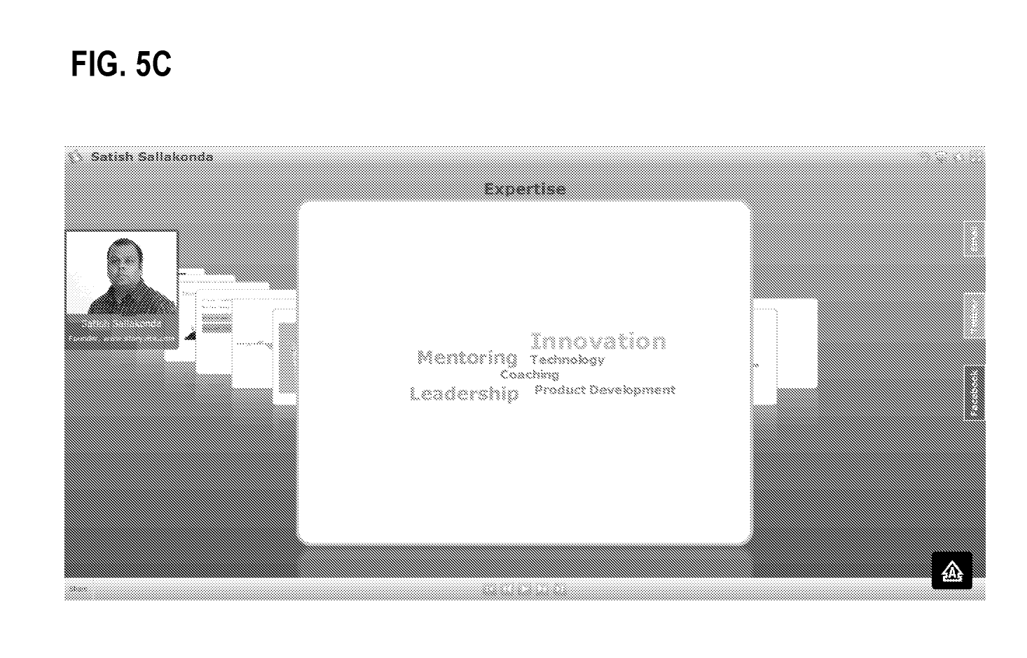

FIG. 5A1 represents an example visual profile player embedded in an embodiment. FIG. 5A2 represents an example user interface for a visual profile player that is generated by presentation logic 260 and played inline in an embodiment. In an embodiment, additional information, links, and more traditional resume-type information may be shown alongside the visual profile. FIG. 5B represents an example user interface for a full-screen visual profile player in an embodiment. In an embodiment, the metadata for Visual Profile information can be stored in the database, file system of any format, in files such as XML files. Appendix A provides example XML code that is associated with the slide presented in the embodiment depicted in FIG. 5C, which shows several blog postings by a user. In an embodiment, the Visual Profile Player plays the content the user has assembled via the editor. The content is served via the XML file or from database or from other file system that stores the metadata about the user's Visual Profile. The user has the ability to embed the content and/or player anywhere on their blogs, websites or any other external system. In an embodiment, Users have the ability to track statistics on the number of times a particular visual profile was viewed or downloaded. FIGS. 7A-C represents an example web page that is generated with various visual elements in an embodiment.

### Searching Visual Profiles

In an embodiment, users may search for visual profiles. Data that is extracted from various sources is aggregated and stored in user data 274 in database 270. Each data item is associated with a particular user, and may be associated with a flag that indicates whether or not the user has selected that data item as part of his visual profile. A user that searches for a profile based on a particular keyword may receive a list of users associated with that keyword. In an embodiment, if a user has not selected a particular data item to be part of his visual profile, the search engine logic will ignore that item, even if the item is associated with the user in database 270. In an embodiment, if a user has not selected a particular data item to be part of his visual profile, the search engine logic will still retrieve the item and will display in the search results with less relevancy. In an embodiment, search results are based on all data items stored for a particular user.

In an embodiment, visual profiles are stored separately from user data. When a user generates a visual profile, the data required for that visual profile is stored in a separate database table in database 270. That data is then associated with the user. When a search request is received by search engine logic, the database table storing the visual profile data is searched. In response to a search, a list of profiles or a list of links to profiles may be returned.

In an embodiment, a user may search based on visual content items. For example, if a user is viewing a profile with a picture of a coffee cup with the word “JAVA” on the side, that user may select the picture and choose a search option. For example, the user right-clicks on the image and then selects the word “search” from a resulting drop-down menu. Search engine logic then performs a search for other visual profiles that utilize the same image. In an embodiment, a search is performed for images that have similar themes. In another embodiment, when a user performs a search based on a content item, the search is based in the keywords associated with that content item.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

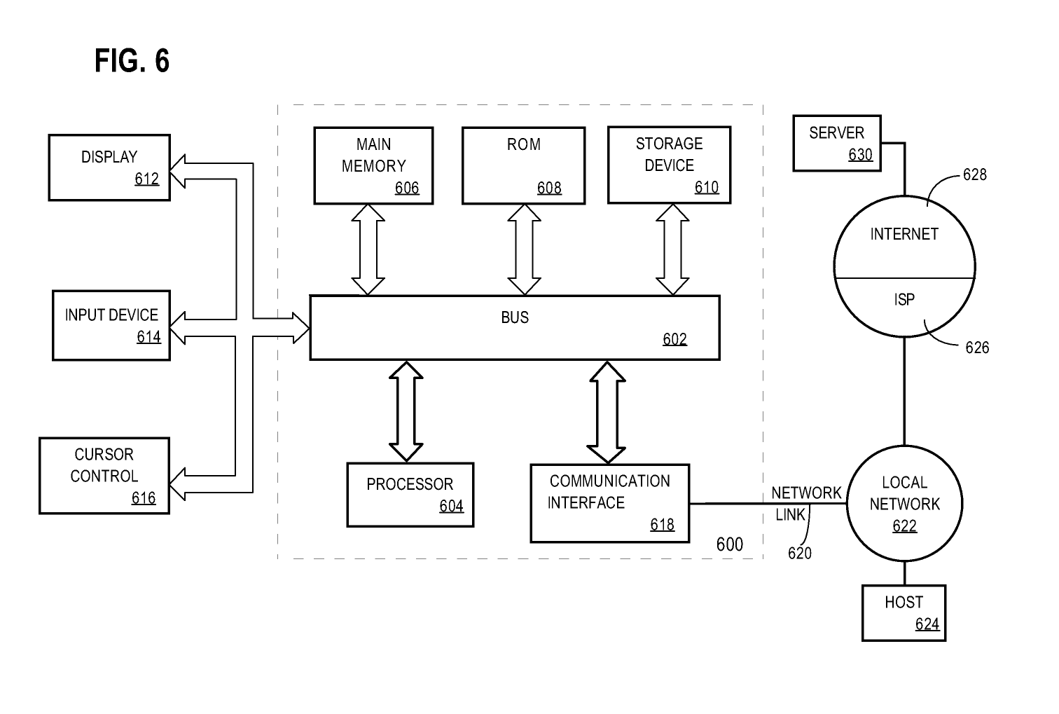

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

APPENDIX A
EXAMPLE XML CODE FOR SLIDE IN FIG. 5C

presentation height=“438”
imageURL=“http://www.storyvite.com/timages/user/6/b/6/c/6b6c2ba9ae4b11e096a
100259031e09c/presentation/Visual_Profile1316356015162_p.jpg”
presentationId=“100”
thumbnailURL=“http://www.storyvite.com/timages/user/6/b/6/c/6b6c2ba9ae4b11e0
96a100259031e09c/presentation/Visual_Profile_t.jpg” title=“XYZ - Visual Profile”
userAltKey=“XYZ” userDisplayName=“XYZ” versionId=“12” width=“585”>
<slide defaultSlide=“false” displaySeq=“6” notes=“” title=“My Blog Posts” transition=“1120”>
<items>
<item height=“438” layer=“0” opacity=“1.0” rotation=“0” shape=“1510” type=“PLAIN_ITEM”
width=“585” xposition=“0” yposition=“−1”>
<fill alpha=“1.0” color=“#FFFFFF” type=“solid”/>
</item>
<item backgroundColor=“” height=“40” htmlText=“<TEXTFORMAT
LEADING=&quot;2&quot;&gt;&lt;P ALIGN=&quot;LEFT&quot;&gt;&lt;FONT
FACE=&quot;Arial&quot; SIZE=&quot;22&quot; COLOR=&quot;#424242&quot;
LETTERSPACING=&quot;0&quot; KERNING=&quot;0&quot;&gt;Some of My Blog
Posts&lt;/FONT&gt;&lt;/P&gt;&lt;/TEXTFORMAT&gt;” layer=“1” opacity=“1.0” plainText=“”
rotation=“0” transitive=“true” type=“TEXT_ITEM” width=“300” xposition=“171”
yposition=“36”/>
<item backgroundColor=“” height=“45” htmlText=“&lt;TEXTFORMAT
LEADING=&quot;2&quot;&gt;&lt;P ALIGN=&quot;LEFT&quot;&gt;&lt;FONT
FACE=&quot;Arial&quot; SIZE=&quot;20&quot; COLOR=&quot;#2B98BF&quot;
LETTERSPACING=&quot;0&quot; KERNING=&quot;0&quot;&gt;&lt;A
HREF=&quot;http://talentedapps.wordpress.com/2009/04/14/how-about-giving-your-boss-a-
performance-review/&quot; TARGET=&quot;_blank&quot;&gt;&lt;FONT
FACE=&quot;Arial&quot; SIZE=&quot;20&quot; COLOR=&quot;#2B98BF&quot;
LETTERSPACING=&quot;0&quot; KERNING=&quot;0&quot;&gt;&lt;FONT
FACE=&quot;Arial&quot; SIZE=&quot;20&quot; COLOR=&quot;#2B98BF&quot;
LETTERSPACING=&quot;0&quot; KERNING=&quot;0&quot;&gt;&lt;U&gt;How about
giving your Boss a Performance
Review?&lt;/U&gt;&lt;/FONT&gt;&lt;/FONT&gt;&lt;/A&gt;&lt;/FONT&gt;&lt;/P&gt;&lt;/TE
XTFORMAT&gt;” layer=“2” opacity=“1.0” plainText=“” rotation=“0” transitive=“true”
type=“TEXT_ITEM” width=“491” xposition=“24” yposition=“253”/>
<item backgroundColor=“” height=“40” htmlText=“&lt;TEXTFORMAT
LEADING=&quot;2&quot;&gt;&lt;P ALIGN=&quot;LEFT&quot;&gt;&lt;FONT
FACE=&quot;Arial&quot; SIZE=&quot;20&quot; COLOR=&quot;#2B98BF&quot;
LETTERSPACING=&quot;0&quot; KERNING=&quot;0&quot;&gt;&lt;A
HREF=&quot;http://talentedapps.wordpress.com/2009/06/10/the-secret-code-of-a-charismatic-
leader/&quot; TARGET=&quot;_blank&quot;&gt;&lt;FONT FACE=&quot;Arial&quot;
SIZE=&quot;20&quot; COLOR=&quot;#2B98BF&quot; LETTERSPACING=&quot;0&quot;
KERNING=&quot;0&quot;&gt;&lt;FONT FACE=&quot;Arial&quot; SIZE=&quot;20&quot;
COLOR=&quot;#2B98BF&quot; LETTERSPACING=&quot;0&quot;
KERNING=&quot;0&quot;&gt;&lt;U&gt;The secret code of a charismatic
leader&lt;/U&gt;&lt;/FONT&gt;&lt;/FONT&gt;&lt;/A&gt;&lt;/FONT&gt;&lt;/P&gt;&lt;/TEX
TFORMAT&gt;” layer=“3” opacity=“1.0” plainText=“” rotation=“0” transitive=“true”
type=“TEXT_ITEM” width=“376” xposition=“183” yposition=“174”/>
<item backgroundColor=“” height=“40” htmlText=“&lt;TEXTFORMAT
LEADING=&quot;2&quot;&gt;&lt;P ALIGN=&quot;LEFT&quot;&gt;&lt;FONT
FACE=&quot;Arial&quot; SIZE=&quot;20&quot; COLOR=&quot;#2B98BF&quot;
LETTERSPACING=&quot;0&quot; KERNING=&quot;0&quot;&gt;&lt;A
HREF=&quot;http://talentedapps.wordpress.com/2009/08/18/our-role-as-leaders-during-times-
of-change/&quot; TARGET=&quot;_blank&quot;&gt;&lt;FONT FACE=&quot;Arial&quot;
SIZE=&quot;20&quot; COLOR=&quot;#2B98BF&quot; LETTERSPACING=&quot;0&quot;
KERNING=&quot;0&quot;&gt;&lt;FONT FACE=&quot;Arial&quot; SIZE=&quot;20&quot;
COLOR=&quot;#2B98BF&quot; LETTERSPACING=&quot;0&quot;
KERNING=&quot;0&quot;&gt;&lt;U&gt;Our Role As Leaders During Times Of
Change&lt;/U&gt;&gt;/FONT&gt;&lt;/FONT&gt;&lt;/A&gt;&lt;/FONT&gt;&lt;/P&gt;&lt;/TE
XTFORMAT&gt;” layer=“4” opacity=“1.0” plainText=“” rotation=“0” transitive=“true”
type=“TEXT_ITEM” width=“444” xposition=“30” yposition=“86”/>
</items>
</slide>

What is claimed is:

1. A method comprising:
automatically gathering data about a user from multiple separate data sources over the Internet; and
automatically generating a visual profile for the user based on the data;
wherein the data sources include a first data source that is different from a second data source;
wherein the visual profile comprises a slide show or video presentation or multimedia content or web page or document;
wherein the method is performed by one or more computing devices.

2. The method of claim 1, wherein the multiple data sources include (a) profile information from Internet job portal (b) profile information from a social or professional networking website (c) profile information available in a resume or a document (4) profile information available from third party sources via API (5) profile information available in webpages via Hypertext Markup Language (5) profile information available in database or disk.

3. The method of claim 1, wherein the step of automatically gathering the data about the user from the multiple separate data sources comprises automatically gathering at least some of the data from a smartphone.

4. The method of claim 1, wherein the step of automatically gathering the data about the user from the multiple separate data sources comprises automatically gathering at least some of the data from internal Human Resource, Recruiting and Talent Management systems.

5. The method of claim 1, wherein the step of automatically gathering the data about the user from the multiple separate data sources comprises automatically gathering at least some of the data from enterprises internal wiki's, blogs, email or other data storages.

6. The method of claim 1, wherein the step of automatically gathering the data about the user from the multiple separate data sources comprises automatically gathering at least some of the data from a blog of the user.

7. The method of claim 1, wherein the step of automatically gathering the data about the user from the multiple separate data sources comprises automatically gathering at least some of the data from a comment posted by the user to a blog of a user other than the current user.

8. The method of claim 1, wherein the step of automatically gathering the data about the user from the multiple separate data sources comprises automatically gathering at least some of the data from information sharing sites including Twitter where the user either shared the data or where the user is referenced.

9. The method of claim 1, wherein the step of automatically gathering the data about the user from the multiple separate data sources comprises automatically gathering at least some of the data from influence measuring sharing sites including Klout where the user's influence is measured or where the user is discussed in an online article.

10. The method of claim 1, wherein the step of automatically gathering the data about the user from the multiple separate data sources comprises automatically gathering at least some of the data from an online review of a book authored by the user.

11. The method of claim 1, wherein the step of automatically gathering the data about the user from the multiple separate data sources comprises automatically extracting information from the data sources based on Hypertext Markup Language tags contained within the data sources.

12. The method of claim 1, wherein the step of automatically gathering the data about the user from the multiple separate data sources comprises automatically crawling the Internet for a new source that is not yet contained in the multiple separate data sources and comparing data from the new source with data that is already contained in the multiple separate data sources.

13. The method of claim 1, wherein the step of automatically gathering the data about the user from the multiple separate data sources comprises automatically extracting video content from the multiple separate data sources.

14. The method of claim 1, wherein the step of automatically gathering the data about the user from the multiple separate data sources comprises automatically extracting flash multimedia presentations or Silverlight multimedia presentations from the multiple separate data sources.

15. A non-transitory computer-readable storage medium storing instructions which, when executed by one or more processors, cause the one or more processors to perform steps comprising:
automatically gathering data about a user from multiple separate data sources over the Internet; and
automatically generating a visual profile for the user based on the data;
wherein the data sources include a first data source that is different from a second data source;
wherein the visual profile comprises a slide show or video presentation or multimedia content or web page or document.

16. The non-transitory computer-readable storage medium of claim 15, wherein the multiple data sources include (a) profile information from Internet job portal (b) profile information from a social or professional networking website (c) profile information available in a resume or a document (4) profile information available from third party sources via API (5) profile information available in webpages via Hypertext Markup Language (5) profile information available in database or disk.

17. The non-transitory computer-readable storage medium of claim 15, wherein the step of automatically gathering the data about the user from the multiple separate data sources comprises automatically gathering at least some of the data from a smartphone.

18. The non-transitory computer-readable storage medium of claim 15, wherein the step of automatically gathering the data about the user from the multiple separate data sources comprises automatically gathering at least some of the data from internal Human Resource, Recruiting and Talent Management systems.

19. The non-transitory computer-readable storage medium of claim 15, wherein the step of automatically gathering the data about the user from the multiple separate data sources comprises automatically gathering at least some of the data from enterprises internal wiki's, blogs, email or other data storages.

20. The non-transitory computer-readable storage medium of claim 15, wherein the step of automatically gathering the data about the user from the multiple separate data sources comprises automatically gathering at least some of the data from a blog of the user.

21. The non-transitory computer-readable storage medium of claim 15, wherein the step of automatically gathering the data about the user from the multiple separate data sources comprises automatically gathering at least some of the data from a comment posted by the user to a blog of a user other than the current user.

22. The non-transitory computer-readable storage medium of claim 15, wherein the step of automatically gathering the data about the user from the multiple separate data sources comprises automatically gathering at least some of the data from information sharing sites including Twitter where the user either shared the data or where the user is referenced.

23. The non-transitory computer-readable storage medium of claim 15, wherein the step of automatically gathering the data about the user from the multiple separate data sources comprises automatically gathering at least some of the data from influence measuring sharing sites including Klout where the user's influence is measured or where the user is discussed in an online article.

24. The non-transitory computer-readable storage medium of claim 15, wherein the step of automatically gathering the data about the user from the multiple separate data sources comprises automatically gathering at least some of the data from an online review of a book authored by the user.

25. The non-transitory computer-readable storage medium of claim 15, wherein the step of automatically gathering the data about the user from the multiple separate data sources comprises automatically extracting information from the data sources based on Hypertext Markup Language tags contained within the data sources.

26. The non-transitory computer-readable storage medium of claim 15, wherein the step of automatically gathering the data about the user from the multiple separate data sources comprises automatically crawling the Internet for a new source that is not yet contained in the multiple separate data sources and comparing data from the new source with data that is already contained in the multiple separate data sources.

27. The non-transitory computer-readable storage medium of claim 15, wherein the step of automatically gathering the data about the user from the multiple separate data sources comprises automatically extracting video content from the multiple separate data sources.

28. The non-transitory computer-readable storage medium of claim 15, wherein the step of automatically gathering the data about the user from the multiple separate data sources comprises automatically extracting flash multimedia presentations or Silverlight multimedia presentations from the multiple separate data sources.
